(19) United States
(12) Patent Application Publication
(10) Pub. No.: US 2025/0229467 A1
(43) Pub. Date: Jul. 17, 2025

(54) AMPHIPHILIC INTERLAYERS FOR POLYMER BASED CONTAINERS

(71) Applicant: West Pharmaceutical Services, Inc., Exton, PA (US)

(72) Inventor: Liang FANG, Exton, PA (US)

(21) Appl. No.: 18/855,715

(22) PCT Filed: Apr. 12, 2023
(86) PCT No.: PCT/US2023/065659

§ 371 Date: Oct. 10, 2024

Related U.S. Application Data
(60) Provisional application No. 63/330,200, filed on Apr. 12, 2022.

(51) Int. Cl. B29C 45/00; B29C 45/14; B29C 45/16; B29K 69/00; B29L 9/00; B29L 31/00

(52) U.S. Cl. CPC B29C 45/0001; B29C 45/0003; B29C 45/14811; B29C 45/1639; B29K 2023/04; B29K 2069/00; B29K 2995/0018; B29K 2995/0067; B29L 2009/00; B29L 2031/7544

(57) ABSTRACT

Layered polymer materials include a first layer including a first cyclic olefin polymer or a first cyclic olefin copolymer, a third layer including a second cyclic olefin polymer or a second cyclic olefin copolymer, and a second layer including an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP. The second layer can be in contact with and be between the first layer and the third layer. The layered polymer material can be used to construct the body of a vial or a syringe. Methods of making the layered polymer material and kits containing the layered polymer material or containers having a body constructed from the layered polymer material are also described.

### CROSS REFERENCE TO RELATED APPLICATIONS

This application claims the benefit of U.S. Provisional Patent App. No. 63/330,200, filed Apr. 12, 2022, the disclosure of which is hereby incorporated by reference herein.

### TECHNICAL FIELD

This disclosure relates to layered polymer materials having at least a tripled layered construction for use in pharmaceutical containers, in which the first and third (outer) layers are cyclic olefin polymers (COP) or cyclic olefin copolymers (COC) and in which the second layer (interlayer), which is sandwiched between the first and third layers, is comprised of an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

### BACKGROUND

COP or COC based pharmaceutical containers have better break resistance and pH stability, and less particle delamination issues than glass containers. As such, they are increasingly used for pharmaceutical packaging. However, they also suffer from high oxygen gas permeability and can cause oxygen-sensitive medication to degrade during long term storage. This degradation issue could also lead to global drug shortage problems when the shelf-life of the parenteral drugs are shortened unexpectedly.

To overcome the problems associated with such pharmaceutical containers, hydrophilic polymers with high oxygen barrier properties, such as ethylene-vinyl alcohol (EVOH), have been co-injection molded onto the outer surfaces of COP/COC containers. However, the adhesion between the hydrophilic polymer and hydrophobic COP/COC surfaces is poor and allowing oxygen to enter through the gaps between the incompatible layered structure. Accordingly, the prior attempts to modify COC/COP containers by directly molding a hydrophilic oxygen barrier layer onto the hydrophobic COP/COP containers failed because of the poor adhesion between the layers.

Therefore, an improved COP or COC based pharmaceutical container that provides for improved resistance to oxidation of medications (i.e., degradation of medications stored in the container due to oxygen entering the container through the walls of the container) is needed.

### SUMMARY

Layered polymer materials are described that include at least two outer layers formed from COP or COC between which an interlayer comprised of an amphiphilic polymer is sandwiched. The amphiphilic polymer used in the interlayer has a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP. The layered polymer materials are preferable triple layered but additional layers may be added to the at least two outer layers on the side of the respective outer layer that is not contacting the interlayer.

Accordingly, in one embodiment, a layered polymer material comprises a first layer comprised of a first cyclic olefin polymer or a first cyclic olefin copolymer, a third layer comprised of a second cyclic olefin polymer or a second cyclic olefin copolymer, and a second layer in contact with and between the first layer and the third layer. The second layer is comprised of an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP. In certain embodiments, the first and third layer surround the second layer.

The second (middle) layer can be modified to include ultraviolet light absorbing materials having aromatic rings and/or an anti-oxidant. In certain embodiments, the amphiphilic polymer has a hydrophilic component with a Hansen Solubility Parameter distance of 17 MPa^{1/2} or greater from oxygen gas. In other embodiments, the amphiphilic polymer has a hydrophilic component with a Hansen Solubility Parameter distance of 4 MPa^{1/2} or less from the first layer and the third layer.

A variety of different amphiphilic polymers can be used. In one embodiment, the amphiphilic polymer has a chemical formula of:

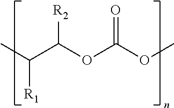

In certain embodiments, R₁ and R₂ are alkylene groups. In some embodiments, the amphiphilic polymer is poly(ethylene carbonate) or propylene carbonate. In other embodiments, the amphiphilic polymer is poly(ethylene- co-acrylic acid) or poly(ethylene- co-methyl acrylic acid).

Methods of generating the layered polymer materials are also described including injection molding the first layer comprised of a first cyclic olefin polymer or a first cyclic olefin copolymer, injection molding the third layer comprised of a second cyclic olefin polymer or a second cyclic olefin copolymer, and injection molding the second layer comprised of the amphiphilic polymer between the first and third layer such that second layer is in contact with and between the first layer and the third layer. In some embodiments, the polymers have already polymerized and the method is carried out under conditions under which the polymers are liquid. Specifically, the polymers may be supplied as pellets which are melted prior to direct injection.

The layered polymer material can be used to construct the body of a container such as e.g., a vial or a syringe. In certain embodiments, the container can be sealed. The layered polymer material can also be sterilized or the containers having a body constructed from the layered polymer material (e.g. vials or syringes) provided as part of kit. The containers having a body constructed from the layered polymer material (e.g. vials or syringes) can also be loaded with a pharmaceutical composition.

### BRIEF DESCRIPTION OF THE DRAWINGS

The summary, as well as the following detailed description, is further understood when read in conjunction with the appended drawings. For the purpose of illustrating, exemplary embodiments are shown in the drawings. However, the embodiments are not limited to the specific methods and compositions disclosed and the drawings are not necessarily drawn to scale. In the drawings:

FIG. 1 shows a cross-sectional view of an injection molded container having a three-layered structure of the disclosure. With reference to FIG. 1, the layers are labelled 1-3. Layers 1 and 3 are a COP/COC layer. Layer 2 (the interlayer) is an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

FIG. 2A shows a cross-sectional view of vial or bottle having a three-layered structure of the disclosure. FIG. 2B shows a diagram of a syringe having walls containing the three-layered structure of the disclosure FIG. 3C shows examples of bags having the three-layered structure of the disclosure. In FIG. 2A-2C, the outer layers are a COP/COC layer. The interlayer is an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized, and that logical structural, mechanical, electrical, and/or chemical changes may be made without departing from the spirit or scope of the invention. To avoid detail not necessary to enable those skilled in the art to practice the embodiments described herein, the description may omit certain information known to those skilled in the art.

Using Hansen Solubility Parameters principles, amphiphilic polymers can be selected that both behave as a good oxygen barrier and adhere to the hydrophobic COP/COC surfaces strongly for use in COP/COC containers. Specifically, using Hansen Solubility Parameters principles, an amphiphilic-polymer-based interlayer between two COP/COC layers is designed to form a three-layered structure that has good adhesion between the three individual layers, wherein the middle layer (interlayer) in these structures behaves as a bi-functional tie layer and oxygen barrier.

Accordingly, a tri-layered polymer material in which an interlayer comprised of an amphiphilic polymer is sandwiched between COP/COC layers is described. The interlayer has certain specific features namely, a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

Compared to constructs only containing COP/COC layers, tri-layered layered polymer materials have reduced gas permeability which enables them to be suitable for longer storage of oxygen sensitive therapeutics (e.g., medications).

### Definitions

Unless defined otherwise, all technical and scientific terms used herein have the same meaning as commonly understood by one of ordinary skill in the art to which the invention pertains. In describing and claiming the present invention, the following terminology will be used.

As used herein, the articles “a” and “an” are used to refer to one or to more than one (i.e., to at least one) of the grammatical object of the article. By way of example, “an element” means one element or more than one element.

As used herein when referring to a measurable value such as an amount, a temporal duration, and the like, the term “about” is meant to encompass variations of +20% or #10%, more preferably +5%, even more preferably +1%, and still more preferably +0.1% from the specified value, as such variations are appropriate to perform the disclosed methods.

As used herein, the terms “comprising,” “including,” “containing,” “comprised”, and “characterized by” are exchangeable, inclusive, open-ended and do not exclude additional, unrecited elements or method steps. Any recitation herein of the term “comprising,” particularly in a description of components of a composition or in a description of elements of a device, is understood to encompass those compositions and methods consisting essentially of and consisting of the recited components or elements.

As used herein, the term “consisting of” excludes any element, step, or ingredient not specified in the claim element.

As used herein, the term “therapeutic compound” includes any compound or biologic (e.g., antibody, nucleotide, antibody fragment, peptide) for treatment.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Layered Polymer Materials

The disclosure provides for layered polymer materials having at least three layers, whereby the middle layer is sandwiched between and in contact with the outer layers. In some embodiments, the layered polymer material only has three layers. In other embodiments, the layered polymer material has further layers. In some embodiments, the middle layer is constructed such that it adheres to the COC/COP outer layers.

In certain embodiments, the outer layers of the layered polymer materials are formed from cyclic olefin polymers and/or cyclic olefin copolymer and the middle layer is formed from an amphiphilic polymer. Without being bound by theory, the amphiphilic polymer is thought to improve adhesion of the layers such that no gap will be formed between the polymers layers that will allow oxygen to leak into the container. In some embodiments, the amphiphilic polymer has the characteristics described in Example 2 below.

The layered polymer material can be used to construct a body of a container for a parenteral medication, such as a vial, cartridge, or syringe. In one embodiment, the first layer is the outer layer of the layered polymer material, and the third layer is an inner layer of the layered polymer material in contact with, for example, a liquid or solid (such as e.g., a parenteral medication) stored within the layered polymer material.

Accordingly, one embodiment of the disclosure is an layered polymer material including a first layer comprised of a first cyclic olefin polymer or a first cyclic olefin copolymer, a third layer comprised of a second cyclic olefin polymer or a second cyclic olefin copolymer, and a second layer, in contact with and between the first layer and the second layer, comprised of an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

In one embodiment, the first layer is comprised of a first cyclic olefin polymer. In another embodiment, the first layer is comprised of a first cyclic olefin copolymer. In another embodiment, the third layer is comprised of a second cyclic olefin polymer that is different from the first cyclic olefin polymer. In yet another embodiment, the third layer is comprised of a second cyclic olefin copolymer that is different from the first cyclic olefin copolymer.

The cyclic olefin polymer and cyclic olefin copolymer in the first layer and/or the second layer can be independently selected such as, for example, the first layer is comprised of a cyclic olefin polymer and the second layer is comprised of cyclic olefin copolymer. Even when the first and second layer are constructed of the same category of polymer (i.e., cyclic olefin polymer or cyclic olefin copolymer), a different type of polymer may be used in each layer. In a specific embodiment, the first layer is comprised of a first cyclic olefin polymer, the second layer is comprised of a second cyclic olefin polymer, and the first cyclic olefin polymer and the second cyclic olefin polymer are the same. In another embodiment, the first layer is comprised of a first cyclic olefin copolymer, the second layer is comprised of a second cyclic olefin copolymer, and the first cyclic olefin copolymer and the second cyclic olefin copolymer are the same.

In the layered polymer materials of the disclosure, the first and third layer surround the second layer, in particular when viewed from a cross-sectional perspective. The first and third layer are in contact with the second layer such there is no gap between the layers.

The second or middle layer of the polymer material is comprised of an amphiphilic polymer. In some embodiments, the hydrophobic component of the amphiphilic polymer has a op and/or on close to 0. In other embodiments, the amphiphilic polymer has a Hansen Solubility Parameter distance of 17 MPa^{1/2} or greater from oxygen gas. In certain embodiments, the amphiphilic polymer has a Hansen Solubility Parameter distance of 4 MPa^{1/2} or less from the first layer and the third layer.

In some embodiments, the amphiphilic polymer in the second layer has higher op values or higher da values (δ_{d}>18). In other embodiments, the amphiphilic polymer comprises a non-polar polymer.

In one embodiment, the amphiphilic polymer is poly(ethylene carbonate) having a set of Hansen Solubility Parameter of δ_{d}, δₚ, δₕ=14.3, 16.5, 4.9. This polymer has a HSP distance of 17.2 MPa^{1/2} from oxygen and, without being bound by theory, thought to be able to behave as a good oxygen barrier.

In a specific embodiment, the amphiphilic polymer is poly(ethylene carbonate) and the first layer is a first cyclic olefin polymer. In another embodiment, the amphiphilic polymer is poly(ethylene carbonate), the first layer is a first cyclic olefin polymer, the second layer is a second cyclic olefin polymer, which is the same as the first cyclic olefin polymer.

A variety of amphiphilic polymers may be used. For example, the amphiphilic polymer may comprise polyethylene or a derivative thereof, such a poly(ethylene carbonate) or a derivative thereof. The amphiphilic polymer may comprise a poly(alkylene carbonate) having the structure of Formula I:

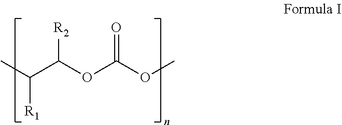

whereby, R₁ and R₂ can be alkylene group. The non-polar, hydrophobic alkylene groups can have closer HSP distance toward COP/COC, and thus can be used to attach the modified poly(ethylene carbonate) onto COP/COC materials (they typically have lower δₚ, δₕ values close to zero, like polyethylene). Unlike EVOH or other hydrophilic oxygen barriers, which have a long HSP distance toward COP/COC and thus have poor adhesion toward COP/COC.

Without being bound by theory, it is thought that R₁ and R₂ alkylene groups introduce hydrophobicity into the hydrophilic poly(ethylene carbonate). In certain embodiments of the disclosure, the commercially available poly(ethylene carbonate) polymers are used as the amphiphilic polymer. Commercial grade of QPAC®25 poly(ethylene carbonate), which has a chemical formula of (C3H403) n, and QPAC®40 (propylene carbonate), which has a chemical formula of (C4H603) n, are examples of suitable amphiphilic polymer that work as a tie layer between the two COP/COC layer and as an oxygen barrier.

Other commercially available amphiphilic polymers with dual components that fulfill the HSP requirements listed in analysis shown in Example 2 can also be used. Examples of such suitable amphiphilic polymers are poly(ethylene- co-acrylic acid) or poly(ethylene- co-methyl acrylic acid).

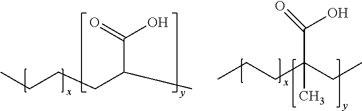

Poly(ethylene-co-acrylic acid) Poly(ethylene-co-methyl acrylic acid) Again, the polyethylene component (δ_{d}, δₚ, δₕ=16.9, 0.8, 2.8) has a set of HSP close to COC/COP (δ_{d}, δₚ, δₕ=18.0, 3.0, 2.0), while the poly(methyl acrylic acid) component could have a HSP of (δ_{d}, δₚ, δₕ=20, 5.7, 11.6) that has a decent HSP distance of ˜17 MPa^{1/2} from oxygen gas.

Accordingly, in some embodiments of the layered polymer material, the amphiphilic polymer has a chemical formula of:

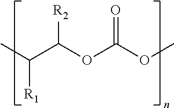

In certain embodiments, R₁ and R₂ are alkylene groups. In another embodiment, the amphiphilic polymer is poly(ethylene carbonate), propylene carbonate or a combination thereof. Alternatively, in some embodiments, the amphiphilic polymer is poly(ethylene- co-acrylic acid), poly(ethylene- co-methyl acrylic acid) or combinations thereof.

Without being bound by theory, it is thought that the new layered polymer material blocks a wider wavelength range of UV thus can protect the medication stored in the component (such as e.g., a container) better in day light. UV absorbers with aromatic rings can be intentionally added into the middle layer to block more UV.

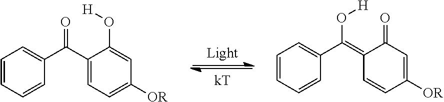

Accordingly, in certain embodiments of the disclosure, the second layer is modified to contain an ultraviolet absorbing material. Examples of suitable ultraviolet absorbing materials include but are not limited to hydroxy benzophenone, hydroxyphenylbenzotriazole, benzophenones, enzotriazoles, hydroxyphenyltriazines, oxanilides, camphors, cinnamates, and other triazines. In one embodiment, the second layer is further comprised of ultraviolet light absorbing materials having aromatic rings.

Additional modifications to the second layer can be carried out. In certain embodiments, the second layer comprises a mixture of the amphiphilic polymer and an anti-oxidant such as butylated hydroxytoluene or Irganox® 1010, Irganox® 1076 and Irganox® 1098. Without being bound by theory, it is thought that the anti-oxidant removes oxygen while it passes through the middle layer.

### Vials, Syringes, and Kits

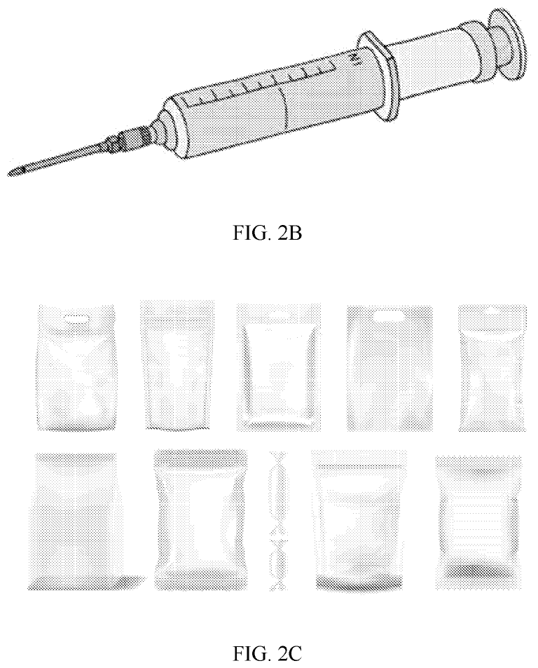

The disclosure also provides containers, such as vials and syringes, constructed from the layered polymer material and kits containing these vials and syringes. Examples of layered polymer materials of the disclosure are shown in FIG. 2A-FIG. 2C. As is illustrated in FIG. 2A and FIG. 2B, a vial or syringe having a body constructed from the polymeric material can be sealed. The disclosure also encompasses bags constructed from the layered polymer material.

Accordingly, one embodiment of the disclosure is directed to a vial including a body made of the layered polymer material. The vial can be sealed and/or sterilized. In certain embodiments, the vial is packaged with a pharmaceutical composition. The pharmaceutical composition contains a therapeutic compound and a pharmaceutically acceptable carrier. In some embodiments, the pharmaceutical composition is ready for administration.

Yet another embodiment of the disclosure is directed to a syringe including a body made of the layered polymer material. The syringe can be sealed and/or sterilized. In certain embodiments, the syringe is packaged with a pharmaceutical composition. In other embodiments, the pharmaceutical composition is ready for administration.

Another embodiment of the disclosure is a kit comprising the vial and/or the syringe and, optionally, instructions for use. The kit can be sterilized.

### Methods of Generating Layered Polymer Materials

Yet another aspect of the disclosure is directed to methods of generating the layered polymer materials described herein. In one embodiment, the method includes generating the layered polymer materials by direct injection molding.

The process of forming this three-layer structure is stepwise injection molding, including simultaneous molding such as being extruded from a die. No surface treatment is needed during the stepwise injection molding. In certain embodiments, polymer resins as pellets are used directly in each step of injection molding.

The method of generating the construct by injection molding includes providing a mold that is configured to provide the desired shape of the layered polymer material after direct injection molding. In certain embodiments, the mold is configured to contain a removable spacer that is configured for the third layer. As a result of the presence of the space a cavity is formed for each of the first and second layer. In that embodiment, the method includes providing a cyclic olefin polymer (COP) and/or cyclic olefin copolymer (COC) in liquid form thus that the COP and/or COC can be injected into (i.e., introduced) into the cavity formed for each of the first and second layer under conditions allowing for the polymer to be molten. Upon formation of the first and second layer, the spacer is removed, and the amphiphilic polymer is injected (i.e., introduced) between the first and second layer under conditions allowing for the polymer to be molten and formation of the third layer thereby creating the layered polymer material. Accordingly, the method includes removal of the spacer after formation of the first and second layer, provision of the amphiphilic polymer and injection (i.e., introduction) between the first and second layer under conditions allowing for the polymer to be molten and formation of the third layer thereby creating the layered polymer material. In certain embodiments, the method includes providing the pellets of the polymers which are melted. The method may also include cooling the mold and/or polymer after injection of the first, second, and/or third layer. In certain embodiments, the method includes forming a container (e.g. a vial or syringe) having a body constructed from the layered polymer material.

In certain embodiments, the method includes sterilizing the layered polymer material. In other embodiments, the method includes loading a container (such as e.g., a vial or a syringe) constructed from the layered polymer material with a pharmaceutical composition. The pharmaceutical composition contains a therapeutic compound and a pharmaceutically acceptable carrier. In certain embodiments, the container having a body constructed from the layered polymer material containing the pharmaceutical composition is packaged to generate a kit which may include instructions for use. The kit can also be sterilized. Accordingly, the method includes sterilizing the kit.

Yet another embodiment of the disclosure is directed to a method generating the layered polymer material of described above. The method includes injection molding the first layer comprised of a first cyclic olefin polymer or a first cyclic olefin copolymer, injection molding the third layer comprised of a second cyclic olefin polymer or a second cyclic olefin copolymer, and injection molding the second layer comprised of the amphiphilic polymer between the first and third layer such that second layer is in contact with and between the first layer and the third layer.

In some embodiments, the injection molding of the first, second, and third layer is carried out under conditions under which the first cyclic olefin polymer or the first cyclic olefin copolymer, the second cyclic olefin polymer or the second cyclic olefin copolymer, and the amphiphilic polymer are liquid (molten). The first cyclic olefin polymer or the first cyclic olefin copolymer can be injected molded at the same time, before or after the second cyclic olefin polymer or the second cyclic olefin copolymer. In certain embodiments of the method, the polymers are provided as pellets. In one embodiment, the method also includes providing pellets of a first cyclic olefin polymer, a first cyclic olefin copolymer, a second cyclic olefin polymer, a second cyclic olefin copolymer, and/or an amphiphilic polymer. In some embodiments, the method also includes melting the pellets. In other embodiments, the method includes cooling the mold and/or polymer after injection of the first, second, and/or third layer. In further embodiments, the method includes sterilizing the layered polymer material.

It is also contemplated that in lieu of pellets, in certain embodiments, the injection molding of the first, second, and third layer is carried out under conditions allowing polymerization of the first cyclic olefin polymer or the first cyclic olefin copolymer, the second cyclic olefin polymer or the second cyclic olefin copolymer, and the amphiphilic polymer.

Without further description, it is believed that one of ordinary skill in the art can, using the preceding description and the following illustrative examples, make and utilize the compounds of the present invention and practice the claimed methods. The following working examples, therefore, specifically point out the preferred embodiments of the present invention and are not to be construed as limiting in any way the remainder of the disclosure.

### EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

### Example 1-Constructs According to the Disclosure

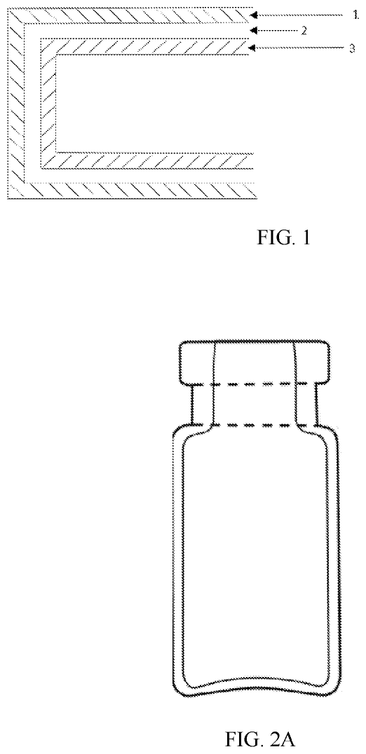

FIG. 1 shows a cross-sectional view of a three-layered injection molded container having outer layers 1 and 3 and an intervening second layer (interlayer). Each of outer layers 1 and 3 are a COP or COC layer. Layer 2 (the interlayer) is an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP. The structure in FIG. 1 may be generated by direct injection molding.

### Example 2-Determination of Appropriate Amphiphilic Layer Characteristics

As noted above, FIG. 1 shows an example of three-layered container of the disclosure. The process of forming this three-layer structure is stepwise injection molding. No surface treatment is needed during the stepwise injection molding. There are a total of three layers in the injection molded container, as depicted in FIG. 1.

The chemical structure of the interlayer polymer needs to be selected by guidance of Hansen Solubility Parameters theory. Oxygen gas has a set of Hansen Solubility Parameter (HSP) of δ_{d}, δₚ, δₕ=14.7, 0, 0, respectively. In order to increase the barrier property of the selected polymer against oxygen, we need to reduce the solubility of oxygen in this polymer needs to be reduced since

Permeabilty=Diffusivity×Solubility.

To reduce the solubility of oxygen in this selected polymer, the HSP distance between the selected polymer and oxygen needs to be maximized. Most non-polar polymers, such as, for example, polyethylene (PE), have a δₚ, δₕ=0, 0, respectively, and thus they are not good barriers for oxygen. Instead, polymers with higher δₚ and δₕ are preferred to be used as oxygen barrier. Thus, poly(ethylene carbonate), which has a set of Hansen Solubility Parameter of δ_{d}, δₚ, δₕ=14.3, 16.5, 4.9, was chosen. This polymer has a HSP distance of 17.2 MPa^{1/2} from oxygen thus can behave as a good oxygen barrier.

Additionally, to work as an effective oxygen barrier in the 3-layered structure shown in FIG. 1, the amphiphilic polymer should also have a component that has a set of Hansen Solubility Parameters (HSP) that are close to those of COC/COP. The smaller the HSP distance, the better the adhesion. According to literature, COC has a set of HSP of (18.0, 3.0, 2.0). Thus, non-polar polymers, such as PE with HSP of (δ_{d}, δₚ, δₕ=16.9, 0.8, 2.8), will have a close HSP distance toward COC, and shall be considered a suitable non-polar component of the amphiphilic polymer that can be injection molded into the middle layer of the 3-layered structure shown in FIG. 1.

It is to be understood that while the disclosure has been described in conjunction with the preferred specific embodiments thereof, that the foregoing description and the examples that follow are intended to illustrate and not limit the scope of the disclosure. It will be understood by those skilled in the art that various changes may be made, and equivalents may be substituted without departing from the scope of the disclosure, and further those other aspects, advantages and modifications will be apparent to those skilled in the art to which the disclosure pertains.

1. A layered polymer material comprising:
a first layer comprised of a first cyclic olefin polymer or a first cyclic olefin copolymer;
a third layer comprised of a second cyclic olefin polymer or a second cyclic olefin copolymer; and
a second layer, in contact with and between the first layer and the third layer, comprised of an amphiphilic polymer having a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

2. The layered polymer material of claim 1, wherein the first layer is comprised of the first cyclic olefin polymer.

3. The layered polymer material of claim 1, wherein the first layer is comprised of the first cyclic olefin copolymer.

4. The layered polymer material of claim 1, wherein the third layer is comprised of the second cyclic olefin polymer.

5. The layered polymer material of claim 1, wherein the third layer is comprised of the second cyclic olefin copolymer.

6. The layered polymer material of claim 1, wherein the first layer and the second layer are comprised of the same cyclic olefin polymer.

7. The layered polymer material of claim 1, wherein the first layer and the second layer are comprised of the same cyclic olefin copolymer.

8. (canceled)

9. The layered polymer material of claim claim 1, wherein the second layer of further comprises an ultraviolet light absorbing material having aromatic rings.

10. The layered polymer material of claim 1, wherein the amphiphilic polymer has a δₕ of 0.

11. The layered polymer material of claim 1, wherein the amphiphilic polymer has a Hansen Solubility Parameter distance of 17 MPa^{1/2} or greater from oxygen gas.

12. The layered polymer material of claim 1, wherein the amphiphilic polymer has a chemical formula of:

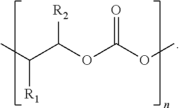

13. The layered polymer material of claim 12, wherein R₁ and R₂ are alkylene groups.

14. The layered polymer material of claim 12, wherein the amphiphilic polymer is poly(ethylene carbonate) or propylene carbonate.

15. The layered polymer material of claim 1, wherein the amphiphilic polymer is poly(ethylene- co-acrylic acid) or poly(ethylene- co-methyl acrylic acid).

16. The layered polymer material of claim 1, wherein the amphiphilic polymer has a Hansen Solubility Parameter distance of 4 MPa^{1/2} or less from the first layer and the third layer.

17-18. (canceled)

19. The layered polymer material of claim 1, wherein the second layer further comprises an anti-oxidant.

20. (canceled)

21. A container including a body made of the layered polymer material of claim 1.

22. The container of claim 21, wherein the container contains a pharmaceutical composition.

23-32. (canceled)

33. A method of generating a layered polymer material, the method comprising:
injection molding a first layer comprised of a first cyclic olefin polymer or a first cyclic olefin copolymer;
injection molding a third layer comprised of a second cyclic olefin polymer or a second cyclic olefin copolymer; and
injection molding a second layer comprised of an amphiphilic polymer between the first and third layer such that second layer is in contact with and between the first layer and the third layer,
wherein the amphiphilic polymer has a hydrophilic component with a Hansen Solubility Parameter distance of 8 MPa^{1/2} or greater from oxygen gas, while at the same time having a hydrophobic component with a Hansen Solubility Parameter distance of 8 MPa^{1/2} or less from COC or COP.

34-38. (canceled)

39. The method of claim 33, wherein the first layer, the second layer, and the third layer are individually formed and wherein the first layer is adhered to the second layer and the second layer is adhered to the third layer.

40-41. (canceled)
